(19) United States
(12) Patent Application Publication
(10) Pub. No.: US 2019/0303474 A1
(43) Pub. Date: Oct. 3, 2019

(54) EFFICIENT PARALLELIZED COMPUTATION OF MULTIPLE TARGET DATA-ELEMENTS

(71) Applicant: LendingClub Corporation, San Francisco, CA (US)

(72) Inventors: SURESH PRAGADA, San Francisco, CA (US); PRAJAKTA TATHAVADKAR, San Francisco, CA (US)

(21) Appl. No.: 15/941,694

(22) Filed: Mar. 30, 2018

(51) Int. Cl. G06F 17/30

(52) U.S. Cl. CPC G06F 17/30445; G06F 17/30463; G06F 17/30958

(57) ABSTRACT

Techniques are provided herein for efficient parallel computation of multiple data-elements. The techniques include storing immediate-dependency information for data-elements, and a set of target data-elements to calculate. A directed acyclic graph for the target data-elements is based on the immediate-dependency information, and is executed, starting at the leaf nodes and in parallel, in order to determine the target data-elements.

### FIELD OF THE INVENTION

The present invention relates to computer-based calculations, and more particularly to efficient parallelized computation of multiple target data-elements.

### BACKGROUND

Many computing systems perform calculations solely based on the equations and processes constructed by operators (e.g. software engineers). This occurs in loan underwriting as well as numerous other fields. Each data-element to be calculated may rely on many underlying data points and data-elements and may be calculated based on these data-elements. That is, each data-element may be calculated from the many underlying data points or data-elements. Further those data-elements may be calculated from yet other data-elements, and so on. In addition to this, in many systems, multiple target data-elements will rely on (be calculated from) the same underlying data-elements for calculation. The issue that system developers and operators run into is that when any of the underlying data-elements is changed, or is calculated in a different way, then every calculation that relies on that data-element has to be rewritten. This can cause a tremendous amount of work. It can also lead to the introduction of bugs, errors, and inconsistencies. In addition to this, when data-elements that need to be calculated rely on the same underlying data-elements, unless the people constructing the processes from calculating those target data-elements are working together, they will likely each calculate the shared underlying data-element separately. This causes inefficiency in the system, because the same data-element is calculated more than one time.

The techniques herein address these issues.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

FIG. 1 depicts a process for efficient parallelized computation of multiple target data-elements.

FIG. 2 depicts an example system for efficient parallelized computation of multiple target data-elements.

FIG. 3 depicts example hardware for efficient parallelized computation of multiple target data-elements.

FIG. 4 depicts an example of a single directed acyclic graph for efficient parallelized computation of multiple target data-elements.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are depicted in block diagram form in order to avoid unnecessarily obscuring the present invention.

### General Overview

The techniques herein provide for efficient parallelization and reduced redundancy for the calculation of target data-elements. The techniques herein work by allowing developers and other operators to define data dependencies for items they want to calculate. In turn, the items on which a particular target data-element rely may also rely on the calculation of other data-elements, and so on. The techniques work by building a single directed acyclic graph of calculations needed to calculate the target data-elements. Further, when multiple data-elements are being calculated, the graph building system will incorporate all of them into the same directed acyclic graph. In this way, when a data-element is needed for the calculation of two different target data-elements, that depended-on data-element will only be calculated one time.

As discussed more below, the techniques include storing immediate dependency information for data-elements. This means that a target data-element will have one level of dependency information and each of the data-elements underneath will have their immediate dependency information, and so on. When the graph builder receives input selecting target data-elements, then the immediate dependency information for those target data-elements is determined by the graph builder. The dependency information for the data-elements includes a list of data-elements on which each data-element depends and how to calculate the data-elements based on its dependencies. The graph builder receives a selection of target data-elements and determines the immediate dependency information for each of those target data-elements (e.g., based on the stored dependency information). Then for each depended-on data-element, the graph build determines its dependencies, and so on. Based on the multiple levels of dependency information, the graph builder generates a single, directed acyclic graph containing all of the target data-elements. For example, if a first target data-element depends on a second target data-element, both the first and second target data-elements will appear in the same single, directed acyclic graph. The graph executer will derive target data-elements by traversing from the leaves of the single, directed acyclic graph. Further, the graph executer can execute each of the leaves in parallel and proceed up the branches as data becomes available.

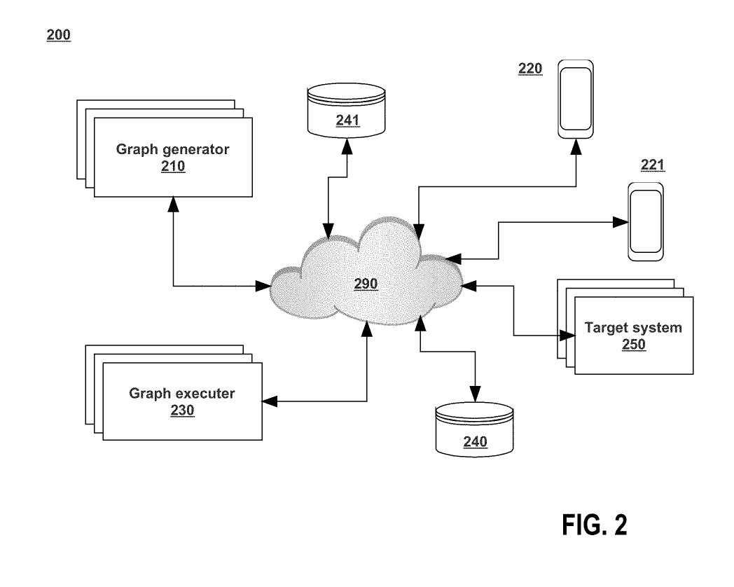

The techniques herein can be used in any circumstance where multiple target data-elements are calculated. For example, if a target system (e.g., target system 250 of FIG. 2) is calculating credit score, fraud scores, and making underwriting decisions, fraud decisions, and credit decisions, then the calculation of many data-elements may be needed and the techniques herein would provide benefits in efficiency of calculation as well as simplification of the engineering or operation time needed when one of the data-elements is updated.

More details of the techniques are given herein.

### Example Process for Efficient Parallelized Computation of Multiple Target Data-elements

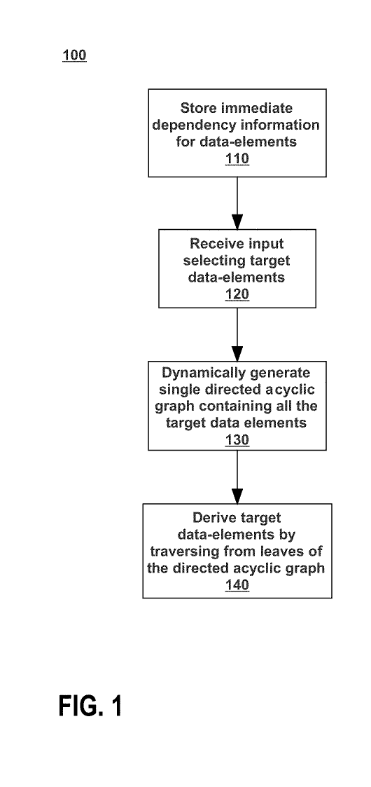

FIG. 1 depicts an example process 100 for efficient parallelized computation of multiple target data-elements. Process 100 proceeds by storing 110 immediate dependency information for data-elements. This immediate dependency information will be used later to create a single, directed acyclic graph. The process 100 continues by receiving 120 input selecting target data-elements. The target data-elements have immediate dependency information in the previously stored 110 dependency information. After receiving 120 input selecting the target data-elements, a single, directed acyclic graph is dynamically generated 130, and that graph contains all of the target data-elements and all of the data-elements on which they depend. After the single, directed acyclic graph is dynamically generated 130, the target data-elements are determined 140 by traversing from the leaves of the directed acyclic graph up the branches until all of the target data-elements have been calculated.

Returning to the top of process 100, immediate dependency information for data-elements is stored 110. Not depicted in FIG. 1, the immediate dependency information may come from developers or operators that need to calculate those target data-elements. For example, a software developer may be writing a process that relies on the calculation of a value (e.g., a credit score). That developer may indicate the data on which the credit score is calculated and the method of calculating it, and that information may be stored 110. Further, whenever someone needs to calculate a new data-element, they can add that data-element along with its immediate dependency information and the method of calculating that target data-element from the immediate dependencies to the stored 110 information. The data-element definitions may be stored in a location accessible by multiple developers and/or operators, including on a database in a file system, etc.

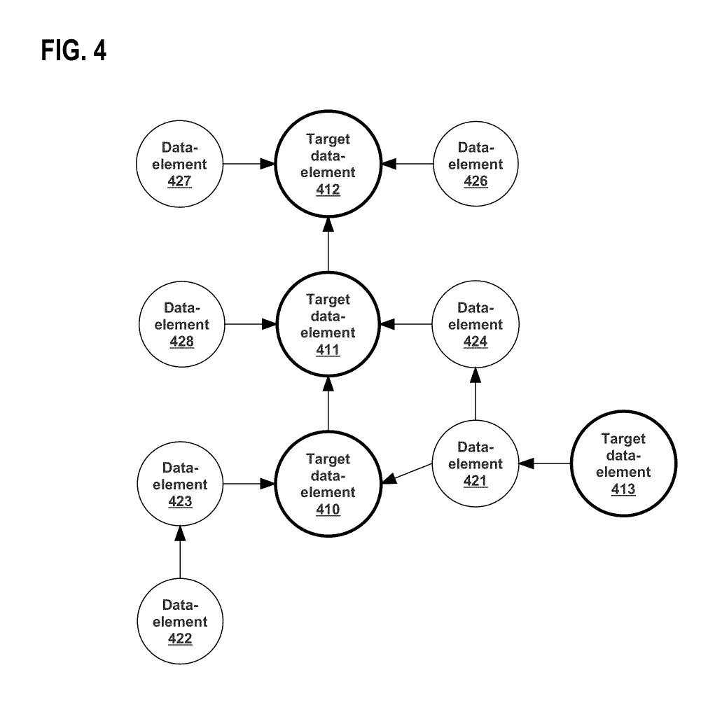

In some embodiments, the developer or operator may select a list of data-elements from which they would like to calculate their target data-element. If a data-element that is needed to calculate their target data-element has not yet been defined (e.g., by another developer, for the calculation of another data-element), then the developer may indicate, for that depended-upon data-element, what further data-elements it depends on and how to calculate it based on its dependencies. For example, if a developer would like to calculate a fraud score for an incoming application, that developer may make the calculation of the fraud score dependent on age, location and credit score. In some embodiments, a credit score may already be in the system. If it is not, however, then that operator may have to define how to calculate the credit score. That credit score may have its own dependencies and its own method of calculation which the operator would then put in. All of these data-element and their dependency information would then be stored 110. Continuing with the example, if a second developer would like to calculate a credit limit, then that developer may indicate credit limit and the data-elements on which it immediately depends in addition to the method of calculating the credit limit. The credit limit may be calculated in part based on the fraud score previously calculated by the other developer. As such, the second developer can select the previously-defined fraud score as one of the data-elements on which it depends. Note that the second developer does not need to define how to calculate that fraud score. Further, if the calculation of credit score is later changed, the calculation of fraud score would not need to be updated, nor would the calculation of credit limit. Restated, the node that represents credit score would be updated and when the single, directed acyclic graph was later generated 130 the new calculation for credit score would be used for fraud score and credit limit. Turning to FIG. 4 in reference to the example above, a credit score could be target data-element 410 and target data-element 411 could be the fraud score, which is depicted as depending on target data-element 410 (credit score) as well as other data-elements 424 and 428. The credit limit would be target data-element 412, which depends on the fraud score data-element 411 (fraud score) as well as other data-elements 427 and 426.

Data-elements may represent any piece of information that a process or other data-element may require. In some embodiments, data-elements are defined as Java objects. Defining the dependencies of one data-element on others may include, in some embodiments, creating a JSON file and/or storing the dependencies in the database or the like. The definition or procedure of how to combine the input data-elements in order to generate a data-element may be written as a service class Java, or in any other appropriate programming language.

An example data-element may be:
FraudScoreDefinition
-- dataObject: FraudScoreCalculator
-- dependencies; [“age”, “location”, “credit score”]

In the example, FraudScoreDefinition is the data-element definition, the dependencies are age, location, and credit score, and the procedure to combine them may be a service class written in Java and named FraudScoreCalculator.

Returning to FIG. 1, process 100 includes receiving 120 input that selects target data-elements. This input can be received in any appropriate manner including, referring to FIG. 2, from one or more client devices 220 or 221 or from a target system 250, etc. Returning to the example above, the graph generation system may receive an indication that a credit score needs to calculated in addition to a fraud score and a credit limit as the target data-elements.

Based on the received 120 input selecting target data-elements, the graph generation system dynamically generates 130 a single, directed acyclic graph containing all of the target data-elements. FIG. 4 depicts an example of a directed acyclic graph for select target data-elements 410, 411, 412, 413. The graph is generated by looking at the immediate dependency information for each of the target data-elements. So, for example, target data-element 412 has immediate dependencies of data-element 427, data-element 426 and target data-element 411. Target data-element 411 has immediate dependencies of data-elements 428 and 424 as well as target data-element 410. Target data-element 410 has a single immediate dependency of data-element 423, data-element 423 has a dependency of data-element 422, and data-element 424 has a dependency of data-element 421, which has its own dependency of target data-element 413. The directed acyclic graph is generated by placing each dependency data-element for each target data-element just below each target data-element. Then, for each depended-upon data-element, the data-elements from which it depends are placed directly below it. This continues until there are no more data-elements with dependency information. Further, no data-element will appear twice in the graph. So, if a data-element is already in the graph, and it appears as dependency information for another data-element, then the graph is connected, and the node representing the repeated data-element is reused.

Once the directed acyclic graph has been generated 130, the graph execution system can determine 140 the target data-elements. Determining 140 the target data-elements can include starting at the leaf nodes of the graph, and executing leaf nodes in parallel. Once each leaf node is executed, the data-elements on which it depends may be executed, and so on, until each target data-element is determined 140. In some embodiments, deriving each individual data-element includes accessing the data-elements on which it relies and executing a program service class associated with the data-element (as discussed elsewhere herein) in order to determine 140 that data-element. Executing that service class will allow calculation of the data-element based on the data-elements from which it depends.

Determining leaf nodes and branches in parallel may include executing the nodes on one or more processors or other computing devices. For example, in some embodiments, graph execution system 230 can include multiple processors or other computing devices (e.g. graphics processing units and/or computer processing units), and each leaf or branch may be calculated on a separate computing device. Once a branch has completed execution and if the data-element calculated is needed for calculation on another branch, then the calculated data-element may be provided to the other branch, executing on a separate computing device (e.g., via local communication or network 290).

In some embodiments, data-elements needed to calculate particular data-elements may not all be available at the same time (e.g., location for a user may not be known until the user types it in and hits submit), and therefore the execution of the branch of the directed, acyclic graph that relies on that data-element may “stall” and wait until that data is available, but only for that branch of the directed, acyclic graph. Other branches that are not waiting on the delayed data-element will continue to execute.

Returning to FIG. 4, the leaf nodes are data-elements 426, 427, 428, 422, and target data-element 413. Each of those data-elements will execute and then subsequent to that each will move up the branch by one. So, after the execution of data-element 422, data-element 423 will execute and from there target data-element 410 can be calculated (assuming data-element 421 is available). After target data-element 413 is available or executes, data-element 421 can execute, and then data-elements 421 and 424. Target data-element 411 can only execute once all of data-element 428, 424 and target data-element 410 are all available. Once target data-element 411 executes, target data-element 412 can be calculated, assuming data-element 427 and 426 have already executed or become available.

As is clear from the example data-elements are not executed more than once, even if they are used in more than one calculation, thereby increasing the efficiency of computation of all of the target data-elements. Further, the parallelization of the execution and calculation of the branches of data-elements increases the efficiency for the calculation of all of the data-elements.

Not depicted in the example of FIG. 4, if data-element 424 additionally relies on a data-element that has yet not yet been received, various of the target data-elements can still be determined even if data-element 424 and data-elements upstream from data-element 424 cannot yet be calculated. For example, after data-elements 422 and 423 as well as 413 and 421 have all executed, target data-element 410 can be determined 140. Because data-element 424 cannot yet execute target data-elements 411 and 412 cannot yet be determined 140. Nevertheless, the system relying on data-elements 410 and 413 can proceed with any calculations or processes relying on target data-elements 410 and 413.

Not depicted in FIG. 1, when immediate dependency information has been updated, that updated immediate dependency information may be stored 110 for later use in the generation 130 of the directed acyclic graph. As discussed elsewhere herein, when a single data-element is updated, the next time the directed acyclic graph is generated, that update to the data-element will be reflected in the graph. As such the individual calculations of target data-elements do not need to be updated, but will seamlessly incorporate the updates to any of the data-elements on which it relies.

In some embodiments, not depicted in FIG. 4, the dependency information for the at least one of the multiple target data-elements do not share any common dependencies with the other data-elements. As such, in some embodiments, that data-element are put in a directed, acyclic graph separate from the other directed, acyclic graph. As such, generating 130 the directed, acyclic graph may include generating more than one directed, acyclic graph (each with 1+ target data-elements therein), and determining 140 the target data-elements may include executing each of the two or more directed acyclic graphs.

Not depicted in FIG. 1, a system may need (and have requested) the target data-elements. As the target data-elements become available, the calculated data-element may be sent to the system that requested calculation of the data-element. For example, referring to FIG. 2, if target system 250 has requested calculation of numerous data-element, then those data-elements may be set to target system 250 (e.g., via network 290) as they are calculated. Further, in some embodiments, more than one target system 250 or device 220, 221 may request calculation of data-elements, and a single graph may be built to determine the value of those data-element, based on the requests from those multiple systems 250 and/or devices and the immediate dependency information (as described elsewhere herein).

Whether all of the requests for data-elements are from a single or multiple systems or devices, the techniques herein provide a reduction in duplicate calculation (by executing each node only once notwithstanding that more than one target data-element may depend on that node) and by parallelization of the execution of the branches (reducing the time needed to calculate multiple data-elements at once).

### System Overview

FIG. 2 depicts an example system 200 for efficient parallelized computation of multiple target data-elements. System 200 includes a graph generation system 210, a graph execution system 230, and a target system 250, all coupled to a network 290. One or more storage systems 240 and 241 may also be coupled to the network. Not depicted in FIG. 2 each of systems 210, 230 and 250 may also have attached or incorporated storage. One or more user devices 220 and 221 may also be coupled to the network 290.

In some embodiments, graph generation system 210 is used to receive the input(s) selecting the target data-elements to calculate and dynamically generating the directed acyclic graph(s) containing all of the target data-elements based on stored immediate dependency information for the data-elements. The dependency information may be stored locally at the graph generation system 210 and/or in storage 240 or 241. In some embodiments, graph execution system 230 can be used to derive target data-elements by traversing from the leaf nodes of the directed acyclic graph up until all of the target data-elements have been calculated, as discussed above. Devices 220 and 221 may be used to input immediate dependency information, which is then stored. Target system 250 may be the system that request calculation of the target data-elements. In some embodiments all of graph generation system, graph execution system and target system all run on the same set of one or more computing devices, or each could run separately.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

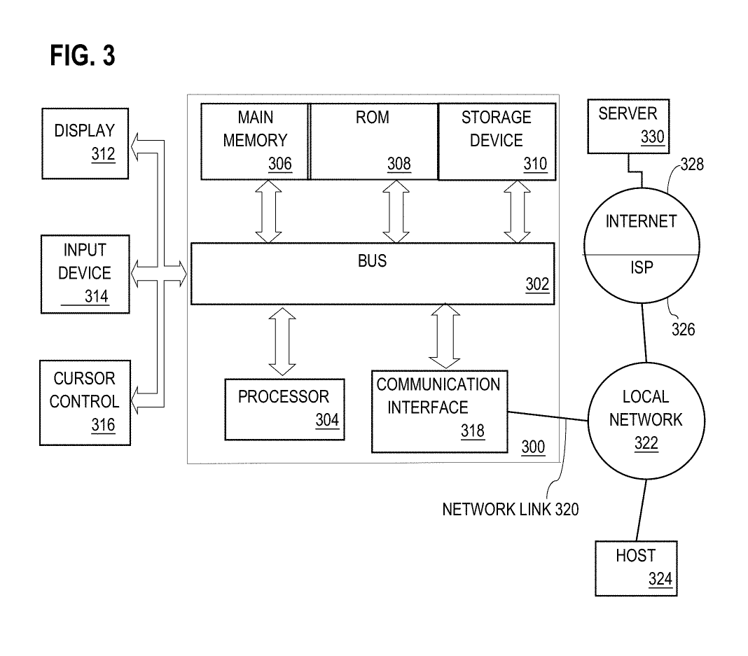

For example, FIG. 3 is a block diagram that illustrates a computer system 300 upon which an embodiment of the invention may be implemented. Computer system 300 includes a bus 302 or other communication mechanism for communicating information, and a hardware processor 304 coupled with bus 302 for processing information. Hardware processor 304 may be, for example, a general purpose microprocessor.

Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Such instructions, when stored in non-transitory storage media accessible to processor 304, render computer system 300 into a special-purpose machine that is customized to perform the operations specified in the instructions.

Computer system 300 further includes a read only memory (ROM) 308 or other static storage device coupled to bus 302 for storing static information and instructions for processor 304. A storage device 310, such as a magnetic disk, optical disk, or solid-state drive is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

Computer system 300 may implement the techniques described herein using customized hard-wired logic, one or more ASICs or FPGAs, firmware and/or program logic which in combination with the computer system causes or programs computer system 300 to be a special-purpose machine. According to one embodiment, the techniques herein are performed by computer system 300 in response to processor 304 executing one or more sequences of one or more instructions contained in main memory 306. Such instructions may be read into main memory 306 from another storage medium, such as storage device 310. Execution of the sequences of instructions contained in main memory 306 causes processor 304 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 310. Volatile media includes dynamic memory, such as main memory 306. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 302. Transmission media can also take the form of acoustic or light waves, such as those generated during radio-wave and infra-red data communications.

Various forms of media may be involved in carrying one or more sequences of one or more instructions to processor 304 for execution. For example, the instructions may initially be carried on a magnetic disk or solid-state drive of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card, cable modem, satellite modem, or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are example forms of transmission media.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method for improving efficiency of data-element-generating operations performed by computing devices, comprising:
storing, for each data-element of a plurality of data-elements, immediate-dependency information that indicates all other data-elements from which the data-element is immediately derived;
receiving input that selects a plurality of target data-elements from the plurality of data-elements;
in response to receiving plurality of the input, dynamically generating a single directed acyclic graph of data dependencies based on the immediate-dependency information;
wherein the single directed acyclic graph of data dependencies includes:
a node for each target data-element, and
below the node for each target data-element, one or more branches;
wherein each node in the one or more branches:
represents a corresponding data-element, and
is directly connected, within the single directed acyclic graph, to nodes representing all data-elements from which the corresponding data-element is immediately derived;
wherein each branch ends in a leaf node that represents a leaf node data-element;
deriving the plurality of target data-elements represented in the single directed acyclic graph, in parallel, starting at the leaf node data-elements and traversing up the branches until each of the target data-elements has been derived;
wherein the method is executed on one more or more computing devices.

2. The method of claim 1, wherein the single directed acyclic graph comprises two or more branches, each corresponding to two or more target data-elements of the plurality of target data-elements, and the two or more branches each derive from a specific, shared data-element node, the method further comprising:
deriving the specific, shared data-element node only once, and
deriving each of two or more target data-elements, at least in part, by traversing the two or more branches up from the specific, shared data-element node to until the two or more target data-elements have been derived.

3. The method of claim 2, the method further comprising:
determining the specific, shared data-elements node based on executing a first branch of the two or more branches, wherein the first branch is associated with a first target data-element of the two or more target data-elements;
deriving a second target data-element of the two or more target data-elements by executing a second branch of the two or more branches starting at the specific, shared data-element node only after the specific, shared data-element node has been calculated based at least in part on executing the first branch.

4. The method of claim 1, wherein a first branch of the one or more branches comprises a dependency of a first target data-element of the plurality of target data-elements on a second target data-element of the plurality of target data-elements, the method further comprising:
determining the second target data-element based on a second branch of the one or more branches corresponding to the second target data-element;
determining the first target data-element by executing a first branch corresponding to the first target data-element, starting at a second target data-element node for the second target data-element.

5. The method of claim 1, wherein a first branch corresponds to a first target data-element of the plurality of target data-elements and a second branch corresponds to a second target data-element of the plurality of target data-elements, and the first branch and second branch each depend from a shared, specific data-element node, and wherein dynamically generating the single directed acyclic graph of data dependencies comprises dynamically generating the single directed acyclic graph with each of the first branch and the second branch connecting to the shared, specific data-element node.

6. The method of claim 1, further comprising:
receiving a change in immediate dependency information for a particular data-element in the plurality of data-elements;
in response to receiving the change in immediate dependency information for the particular data-element in the plurality of data-elements, updating the stored immediate-dependency information to create updated immediate dependency information.

7. The method of claim 6, further comprising:
in response to receiving the input, dynamically generating a single directed acyclic graph of data dependencies based on the updated immediate-dependency information.

8. The method of claim 1, wherein the single directed acyclic graph comprises two or more branches, each corresponding to a target data-element of the plurality of target data-elements, a first branch of the two or more branches depending on a first set of data-elements including a first dependency data-element, and a second branch of the two or more branches depending on a second set of data-elements, the second set of data-elements excluding the first dependency data-element, the method further comprising:
determining that data needed for execution of the first dependency data-element is not available;
in response to determining that the data needed for execution of the first dependency data-element is not available:
executing the second branch;
delaying execution of the first branch until the data for execution of the first dependency data-element is available.

9. The method of claim 1, further comprising:
receiving second input that selects a second plurality of target data-elements from the plurality of data-elements;
in response to receiving the second input, dynamically generating a second directed acyclic graph of data dependencies based on the immediate-dependency information, wherein the single directed acyclic graph and the second directed acyclic graph do not share any data-element nodes;
deriving the second plurality of target data-elements represented in the second directed acyclic graph, in parallel, starting at second leaf node data-elements in the second directed acyclic graph, and traversing up until each of the second plurality of target data-elements has been derived.

10. A system for executing instructions, wherein said instructions are instructions which, when executed by one or more computing devices, cause performance of a process including:
storing, for each data-element of a plurality of data-elements, immediate-dependency information that indicates all other data-elements from which the data-element is immediately derived;
receiving input that selects a plurality of target data-elements from the plurality of data-elements;
in response to receiving plurality of the input, dynamically generating a single directed acyclic graph of data dependencies based on the immediate-dependency information;
wherein the single directed acyclic graph of data dependencies includes:
a node for each target data-element, and
below the node for each target data-element, one or more branches;
wherein each node in the one or more branches:
represents a corresponding data-element, and
is directly connected, within the single directed acyclic graph, to nodes representing all data-elements from which the corresponding data-element is immediately derived;
wherein each branch ends in a leaf node that represents a leaf node data-element;
deriving the plurality of target data-elements represented in the single directed acyclic graph, in parallel, starting at the leaf node data-elements and traversing up the branches until each of the target data-elements has been derived.

11. The system of claim 10, wherein the single directed acyclic graph comprises two or more branches, each corresponding to two or more target data-elements of the plurality of target data-elements, and the two or more branches each derive from a specific, shared data-element node, the process further comprising:
deriving the specific, shared data-element node only once, and
deriving each of two or more target data-elements, at least in part, by traversing the two or more branches up from the specific, shared data-element node to until the two or more target data-elements have been derived.

12. The system of claim 11, the process further comprising:
determining the specific, shared data-elements node based on executing a first branch of the two or more branches, wherein the first branch is associated with a first target data-element of the two or more target data-elements;
deriving a second target data-element of the two or more target data-elements by executing a second branch of the two or more branches starting at the specific, shared data-element node only after the specific, shared data-element node has been calculated based at least in part on executing the first branch.

13. The system of claim 10, wherein a first branch of the one or more branches comprises a dependency of a first target data-element of the plurality of target data-elements on a second target data-element of the plurality of target data-elements, the process further comprising:
determining the second target data-element based on a second branch of the one or more branches corresponding to the second target data-element;
determining the first target data-element by executing a first branch corresponding to the first target data-element, starting at a second target data-element node for the second target data-element.

14. The system of claim 10, wherein a first branch corresponds to a first target data-element of the plurality of target data-elements and a second branch corresponds to a second target data-element of the plurality of target data-elements, and the first branch and second branch each depend from a shared, specific data-element node, and wherein dynamically generating the single directed acyclic graph of data dependencies comprises dynamically generating the single directed acyclic graph with each of the first branch and the second branch connecting to the shared, specific data-element node.

15. The system of claim 10, the process further comprising:
receiving a change in immediate dependency information for a particular data-element in the plurality of data-elements;
in response to receiving the change in immediate dependency information for the particular data-element in the plurality of data-elements, updating the stored immediate-dependency information to create updated immediate dependency information.

16. The system of claim 15, the process further comprising:
in response to receiving the input, dynamically generating a single directed acyclic graph of data dependencies based on the updated immediate-dependency information.

17. The system of claim 10, wherein the single directed acyclic graph comprises two or more branches, each corresponding to a target data-element of the plurality of target data-elements, a first branch of the two or more branches depending on a first set of data-elements including a first dependency data-element, and a second branch of the two or more branches depending on a second set of data-elements, the second set of data-elements excluding the first dependency data-element, the process further comprising:
determining that data needed for execution of the first dependency data-element is not available;
in response to determining that the data needed for execution of the first dependency data-element is not available:
executing the second branch;
delaying execution of the first branch until the data for execution of the first dependency data-element is available.

18. The system of claim 10, the process further comprising:
receiving second input that selects a second plurality of target data-elements from the plurality of data-elements;
in response to receiving the second input, dynamically generating a second directed acyclic graph of data dependencies based on the immediate-dependency information, wherein the single directed acyclic graph and the second directed acyclic graph do not share any data-element nodes;
deriving the second plurality of target data-elements represented in the second directed acyclic graph, in parallel, starting at second leaf node data-elements in the second directed acyclic graph, and traversing up until each of the second plurality of target data-elements has been derived.

19. One or more non-transitory storage media storing instructions which, when executed by one or more computing devices, cause performance of a process including:
storing, for each data-element of a plurality of data-elements, immediate-dependency information that indicates all other data-elements from which the data-element is immediately derived;
receiving input that selects a plurality of target data-elements from the plurality of data-elements;
in response to receiving plurality of the input, dynamically generating a single directed acyclic graph of data dependencies based on the immediate-dependency information;
wherein the single directed acyclic graph of data dependencies includes:
a node for each target data-element, and below the node for each target data-element, one or more branches;
wherein each node in the one or more branches:
represents a corresponding data-element, and
is directly connected, within the single directed acyclic graph, to nodes representing all data-elements from which the corresponding data-element is immediately derived;
wherein each branch ends in a leaf node that represents a leaf node data-element;
deriving the plurality of target data-elements represented in the single directed acyclic graph, in parallel, starting at the leaf node data-elements and traversing up the branches until each of the target data-elements has been derived.

20. The one or more non-transitory storage media of claim 19, wherein the single directed acyclic graph comprises two or more branches, each corresponding to two or more target data-elements of the plurality of target data-elements, and the two or more branches each derive from a specific, shared data-element node, the process further comprising:
deriving the specific, shared data-element node only once, and
deriving each of two or more target data-elements, at least in part, by traversing the two or more branches up from the specific, shared data-element node to until the two or more target data-elements have been derived.
